(19) United States
(12) Patent Application Publication
(10) Pub. No.: US 2026/0342378 A1
(43) Pub. Date: Oct. 29, 2026

(54) DATA DETECTION IN POWER LINE COMMUNICATION (PLC) MESSAGES

(71) Applicant: Bendix Commercial Vehicle Systems LLC, Avon, OH (US)

(72) Inventors: Akshay MISHRA, KANPUR (IN); Amit Babalal NAHAR, PUNE (IN); Pratima VISHWAKARMA, PUNE (IN)

(73) Assignee: Bendix Commercial Vehicle Systems LLC, Avon, OH (US)

(21) Appl. No.: 19/191,630

(22) Filed: Apr. 28, 2025

(51) Int. Cl. H04B 3/56

(52) U.S. Cl. CPC H04B 3/56; H04B 2203/5404; H04B 2203/5483

(57) ABSTRACT

A receiver circuit for decoding data body parts of PLC messages into bit patterns for use by associated processing elements includes a decoupling network, a phase change detection network, a toggle pulse generation network, and a bit pattern generation network. The receiver uses discrete components to generate PLC data body part bit pattern output signals that are usable by associated processing elements for processing the PLC messages. A method decodes a data body part of a power line communication (PLC) message into a bit pattern for use by an associated processing element. A PLC data body part bit pattern output signal is generated, wherein the PLC data body part bit pattern output signal is representative of determined PLC message body data, wherein the generated PLC data body part bit pattern output signal is usable by an associated processing element for processing the PLC message.

### FIELD OF THE DISCLOSURE

This disclosure relates to communication systems and methods and, more particularly, to electronic communication receiver circuits and methods for detection of data from frequency swept carrier waveforms transmitted through power lines of vehicles as power line communication (PLC) messages.

### BACKGROUND

Transceivers for PLC communications have been available. However, these devices are complicated and expensive.

It is therefore desirable to provide electronic communication receiver circuits and methods for detection of data in messages.

It is further desirable to provide electronic communication receiver circuits and methods for detection of data in power line communication (PLC) messages.

It is further desirable to provide electronic communication receiver circuits and methods for detection of data from frequency swept carrier waveforms transmitted through power lines of vehicles as PLC messages.

### SUMMARY

The embodiments herein provide an electronic communication receiver circuit for detection of data in messages.

The embodiments herein further provide an electronic communication receiver circuit and method for detecting data in messages.

The embodiments herein provide an electronic communication receiver circuit for detection of data in PLC messages.

The embodiments herein further provide an electronic communication receiver circuit and method for detecting data in PLC messages.

The embodiments herein provide an electronic communication receiver circuit for detection of data from frequency swept carrier waveforms transmitted through power lines of vehicles as PLC messages.

The embodiments herein further provide an electronic communication receiver circuit and method for detection of data from frequency swept carrier waveforms transmitted through power lines of vehicles as PLC messages.

A receiver circuit is provided for decoding data body parts of PLC messages into bit patterns for use by associated processing elements.

A receiver method is provided for decoding data body parts of PLC messages into bit patterns for use by associated processing elements.

In accordance with an aspect herein, a receiver circuit for decoding a data body part of a PLC message into a bit pattern for use by an associated processing element includes a decoupling network, a phase change detection network, a toggle pulse generation network, and a bit pattern generation network. The receiver circuit includes a decoupling network operably coupled with a power line of an associated vehicle. The decoupler network is operable to receive a raw PLC signal from the power line, and filter the raw PLC signal by removing static features from the raw PLC signal to generate a conditioned PLC output signal. The phase change detection network is operably coupled with the decoupling network and is operable to receive the conditioned PLC output signal, identify phase changes in the received conditioned PLC output signal, and generate a phase change indication output signal representative of the phase changes identified in the received conditioned PLC output signal. The toggle pulse generation network is operably coupled with the phase change detection network and is operable to receive the phase change indication output signal, generate pulses based on the phase changes identified in the conditioned PLC output signal, and generate a toggle pulse output signal representative of the generated pulses. The bit pattern generation network is operably coupled with the toggle pulse generation network and is operable to receive the toggle pulse output signal, determine PLC message body data of a PLC message based on the pulses represented in the received toggle pulse output signal, and generate a PLC data body part bit pattern output signal representative of the determined PLC message body data. The generated PLC data body part bit pattern output signal is usable by an associated processing element for processing the PLC message.

In any of the implementations herein, the decoupling network includes a bandpass circuit operable filter a raw PLC signal to permit non-direct current (AC) signals carried on a power line to pass into a receiver circuit as an AC conditioned PLC signal.

In any of the implementations herein, the phase change detection network includes a differentiator network circuit.

In any of the implementations herein, the differentiator network circuit includes a first differentiator circuit, and a second differentiator circuit.

In any of the implementations herein, the first differentiator circuit is operable to receive a conditioned PLC output signal as an AC conditioned PLC signal, identify phase changes in the received AC conditioned PLC signal, and generate a first differentiated phase change indication output signal representative of the phase changes identified in the received AC conditioned PLC signal.

In any of the implementations herein, the second differentiator circuit is operable to receive a first differentiated phase change indication output signal, accentuate phase changes identified by the first differentiator circuit in the received AC conditioned PLC signal, and generate an accentuated differentiated phase change indication output signal representative of the accentuated phase changes identified by the first differentiator circuit in the received AC conditioned PLC signal.

In any of the implementations herein, the toggle pulse generation network includes an amplifier circuit, an inverter circuit, and an absolute value circuit.

In any of the implementations herein, the amplifier circuit of the toggle pulse generation network is configured to receive a phase change indication output signal from a phase change detection network as an accentuated differentiated phase change indication output signal, amplify the accentuated differentiated phase change indication output signal, and generate an amplified accentuated differentiated phase change indication output signal.

In any of the implementations herein, the inverter circuit of the toggle pulse generation network is configured to receive a phase change indication output signal from a phase change detection network as an accentuated differentiated phase change indication output signal, invert the accentuated differentiated phase change indication output signal, and generate an inverted accentuated differentiated phase change indication output signal.

In any of the implementations herein, the an absolute value circuit of the toggle pulse generation network is configured to receive a generated amplified accentuated differentiated phase change indication output signal, receive the generated inverted accentuated differentiated phase change indication output signal, logically combine the generated amplified accentuated differentiated phase change indication output signal and the generated inverted accentuated differentiated phase change indication output signal, and generate the toggle pulse output signal as an absolute value toggle pulse output signal representative of the pulses generated based on the phase changes identified in a conditioned PLC output signal.

In any of the implementations herein, the bit pattern generation network includes a sample and hold circuit, and an edge trigger circuit.

In any of the implementations herein, the sample and hold circuit of the bit pattern generation network is operable to receive a toggle pulse output signal from a toggle pulse generation network as an absolute value toggle pulse output signal representative of pulses generated based on phase changes identified in a conditioned PLC output signal, sample a logic level of the absolute value toggle pulse output signal, mask extraneous logic level changes by delaying reporting the logic level of the absolute value toggle pulse output signal based on a predetermined hold time period, and generate a sample and hold output signal representative of the delayed logic level reporting of the absolute value toggle pulse output signal based on the predetermined hold time period.

In any of the implementations herein, the edge trigger circuit of the bit pattern generation network is operable to receive a sample and hold output signal, determine a PLC message body data of a PLC message based on pulses represented in the received sample and hold output signal, and generate a PLC data body part bit pattern output signal as a corrected masked bit pattern output signal, wherein the corrected masked bit pattern output signal is representative of a determined PLC message body data.

In accordance with an aspect herein, a method is provided for decoding a data body part of a power line communication (PLC) message into a bit pattern for use by an associated processing element. The method in accordance with the aspect includes receiving a raw PLC signal from the power line, filtering the raw PLC signal by removing static features from the raw PLC signal to generate a conditioned PLC output signal, and identifying phase changes in the conditioned PLC output signal. The method in accordance with the aspect further includes generating a phase change indication output signal representative of the phase changes identified in the received conditioned PLC output signal, generating pulses based on the phase changes identified in the conditioned PLC output signal, generating a toggle pulse output signal representative of the generated pulses, and determining PLC message body data of a PLC message based on the pulses represented in the toggle pulse output signal. The method in accordance with the aspect further includes generating a PLC data body part bit pattern output signal representative of the determined PLC message body data, wherein the generated PLC data body part bit pattern output signal is usable by the associated processing element for processing the PLC message.

In any of the implementations herein, the method further includes filtering the raw PLC signal to permit non-direct current (AC) signals carried on the power line to pass as an AC conditioned PLC signal.

In any of the implementations herein, the method further includes identifying phase changes in the AC conditioned PLC signal, generating a first differentiated phase change indication output signal representative of the phase changes identified in the AC conditioned PLC signal, accentuating the phase changes identified in the AC conditioned PLC signal, and generating an accentuated differentiated phase change indication output signal representative of the accentuated phase changes identified in the AC conditioned PLC signal.

In any of the implementations herein, the method further includes receiving the phase change indication output signal as an accentuated differentiated phase change indication output signal, amplifying the accentuated differentiated phase change indication output signal, generating an amplified accentuated differentiated phase change indication output signal, inverting the accentuated differentiated phase change indication output signal, generating an inverted accentuated differentiated phase change indication output signal, logically combining the generated amplified accentuated differentiated phase change indication output signal and the generated inverted accentuated differentiated phase change indication output signal, and generating the toggle pulse output signal as an absolute value toggle pulse output signal representative of the pulses generated based on the phase changes identified in the conditioned PLC output signal.

In any of the implementations herein, the method further includes sampling a logic level of the absolute value toggle pulse output signal, masking extraneous logic level changes by delaying reporting the logic level of the absolute value toggle pulse output signal based on a predetermined hold time period, generating a sample and hold output signal representative of the delayed logic level reporting of the absolute value toggle pulse output signal based on the predetermined hold time period, determining the PLC message body data of the PLC message based on the pulses represented in the received sample and hold output signal, and generating the PLC data body part bit pattern output signal as a corrected masked bit pattern output signal, the corrected masked bit pattern output signal being representative of the determined PLC message body data.

In accordance with a further aspect, a non-transitory computer readable storage medium is provided comprising computer program instructions for decoding a data body part of a power line communication (PLC) message into a bit pattern for use by an associated processing element, the computer program instructions, when executed by one or more processors, causing the one or more processors to receive a raw PLC signal from the power line, filter the raw PLC signal by removing static features from the raw PLC signal to generate a conditioned PLC output signal, identify phase changes in the conditioned PLC output signal, generate a phase change indication output signal representative of the phase changes identified in the received conditioned PLC output signal, generate pulses based on the phase changes identified in the conditioned PLC output signal, generate a toggle pulse output signal representative of the generated pulses, determine PLC message body data of a PLC message based on the pulses represented in the toggle pulse output signal, and generate a PLC data body part bit pattern output signal representative of the determined PLC message body data, wherein the generated PLC data body part bit pattern output signal is usable by the associated processing element for processing the PLC message.

In any of the implementations, the non-transitory computer readable storage medium comprising the computer program instructions, when executed by the one or more processors, further cause the one or more processors to filter the raw PLC signal to permit non-direct current (AC) signals carried on the power line to pass as an AC conditioned PLC signal.

In any of the implementations, the non-transitory computer readable storage medium comprising the computer program instructions, when executed by the one or more processors, further cause the one or more processors to identify phase changes in the AC conditioned PLC signal, generate a first differentiated phase change indication output signal representative of the phase changes identified in the AC conditioned PLC signal, accentuate the phase changes identified in the AC conditioned PLC signal, and generate an accentuated differentiated phase change indication output signal representative of the accentuated phase changes identified in the AC conditioned PLC signal.

In any of the implementations, the non-transitory computer readable storage medium comprising the computer program instructions, when executed by the one or more processors, further cause the one or more processors to receive the phase change indication output signal as an accentuated differentiated phase change indication output signal, amplify the accentuated differentiated phase change indication output signal, generate an amplified accentuated differentiated phase change indication output signal, invert the accentuated differentiated phase change indication output signal, generate an inverted accentuated differentiated phase change indication output signal, logically combine the generated amplified accentuated differentiated phase change indication output signal and the generated inverted accentuated differentiated phase change indication output signal, and generate the toggle pulse output signal as an absolute value toggle pulse output signal representative of the pulses generated based on the phase changes identified in the conditioned PLC output signal.

In any of the implementations, the non-transitory computer readable storage medium comprising the computer program instructions, when executed by the one or more processors, further cause the one or more processors to sample a logic level of the absolute value toggle pulse output signal, mask extraneous logic level changes by delaying reporting the logic level of the absolute value toggle pulse output signal based on a predetermined hold time period, generate a sample and hold output signal representative of the delayed logic level reporting of the absolute value toggle pulse output signal based on the predetermined hold time period, determine the PLC message body data of the PLC message based on the pulses represented in the received sample and hold output signal, and generate the PLC data body part bit pattern output signal as a corrected masked bit pattern output signal, the corrected masked bit pattern output signal being representative of the determined PLC message body data.

The various examples described above can be combined with each other in various ways in further examples.

It is to be understood that the features mentioned above and those yet to be explained below may be used not only in the respective combinations indicated, but also in other combinations or in isolation without departing from the scope of the claims.

Other aspects, embodiments, features and advantages of the example embodiments will become apparent from the following description of the embodiments, taken together with the accompanying drawings, which illustrate, by way of example, the principles of the example embodiments.

### BRIEF DESCRIPTION OF THE DRAWINGS

In the accompanying drawings which are incorporated in and constitute a part of the specification, example embodiments of the invention are illustrated, which, together with a general description of the invention given above, and the detailed description given below, serve to exemplify the example embodiments of the claimed invention.

FIG. 1 is a block diagram representation of a receiver circuit shown disposed in an associated vehicle for data detection in PLC messages in accordance with an example embodiment.

FIG. 2 is a schematic circuit representation of the decoupling network of FIG. 1 in accordance with an example embodiment.

FIG. 3 is a block diagram representation of the phase change detection network of FIG. 1 in accordance with an example embodiment.

FIG. 4 is a schematic circuit representation of a first differentiator circuit portion of the phase change detection network of FIG. 3 in accordance with an example embodiment.

FIG. 5 is a schematic circuit representation of a second differentiator circuit portion of the phase change detection network of FIG. 3 in accordance with an example embodiment.

FIG. 6 is a block diagram representation of the toggle pulse generation network of FIG. 1 in accordance with an example embodiment.

FIG. 7 is a schematic circuit representation of an amplifier circuit portion of the toggle pulse generation network of FIG. 6 in accordance with an example embodiment.

FIG. 8 is a schematic circuit representation of an inverting circuit portion of the toggle pulse generation network of FIG. 6 in accordance with an example embodiment.

FIG. 9 is a schematic circuit representation of an absolute value circuit portion of the toggle pulse generation network of FIG. 6 in accordance with an example embodiment.

FIG. 10 is a block diagram representation of the bit pattern generation network of FIG. 1 in accordance with an example embodiment.

FIG. 11 is a schematic circuit representation of a sample and hold circuit portion of the bit pattern generation network of FIG. 10 in accordance with an example embodiment.

FIG. 12 is a schematic circuit representation of an edge trigger circuit portion of the bit pattern generation network of FIG. 10 in accordance with an example embodiment.

FIGS. 13A-13H are representative waveform diagrams showing waveform signals taken at various points in the block diagrams and schematic circuit representation of FIGS. 2-12 in accordance with an example embodiment.

FIG. 14 is a flow diagram showing a method for detecting data in PLC messages in accordance with an example embodiment.

### DETAILED DESCRIPTION

In the following description of the present invention reference is made to the accompanying figures which form a part thereof, and in which are shown, by way of illustration, exemplary embodiments illustrating the principles of the present invention and how it is practiced. Other embodiments can be utilized to practice the present invention and structural and functional changes can be made thereto without departing from the scope of the present invention. Various modifications to the example embodiments may be contemplated by one of skill in the art.

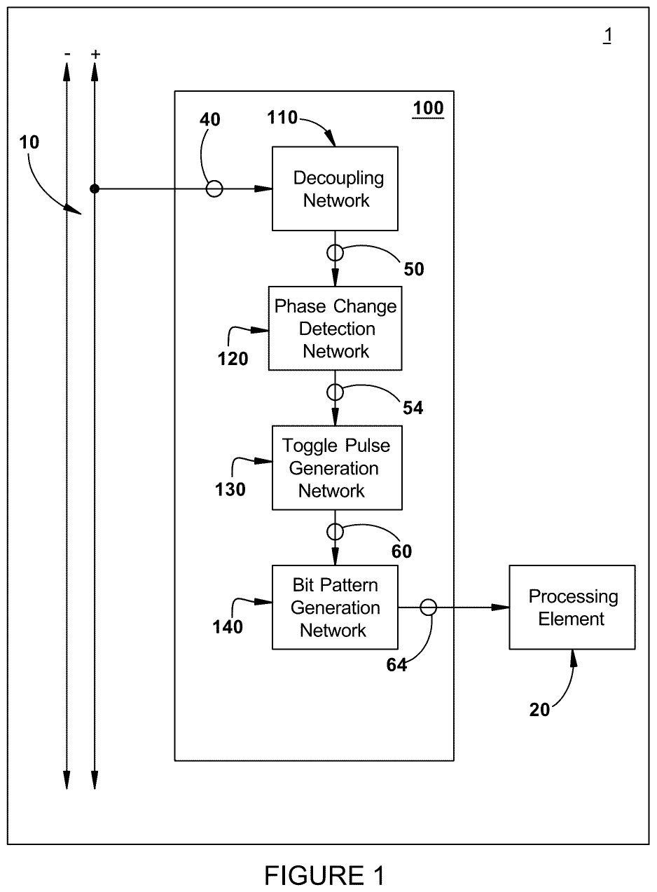

Referring now to the drawings, wherein the showings are for the purpose of illustrating the example embodiments only, and not for purposes of limiting the same, FIG. 1 shows a receiver circuit 100 in accordance with an example implementation. The receiver circuit 100 is shown coupled between a power line 10 and a processing element 20 of an associated vehicle 1. In general, and overall, the receiver circuit 100 is operable to receive PLC messages carried in PLC signals fed onto the power line 10, extract data from the PLC messages, and deliver the extracted data to a processing element 20 of the associated vehicle 1.

In the example embodiment the receiver circuit 100 includes a decoupling network 110, a phase change detection network 120, a toggle pulse generation network 130, and a bit pattern generation network 140. As shown, the decoupling network, the phase change detection network, the toggle pulse generation network, and the bit pattern generation network are connected in series essentially as illustrated for receiving and sequentially processing the PLC signals to extract data from PLC messages carried in the PLC signals for delivery to the processing element 20 of the associate vehicle 1 in accordance with the signal process steps and techniques described herein.

In general, the receiver circuit 100 is operable to decode a data body part of a PLC message into one or more bit patterns for use by the associated processing element 20. In this regard, the decoupling network 110 of the receiver circuit 100 is operably coupled with the power line 10 of the associated vehicle 1 and is operable to receive a raw PLC signal 40 from the power line 10 and filter the raw PLC signal 40 by removing static features from the raw PLC signal 40 to generate a conditioned PLC output signal 50.

Also in this regard, the phase change detection network 120 of the receiver circuit 100 is operably coupled with the decoupling network 110 and is operable to receive the conditioned PLC output signal 50 and identify phase changes in the received conditioned PLC output signal 50. The phase change detection network 120 is further operable to generate a phase change indication output signal 54 representative of the phase changes identified in the received conditioned PLC output signal 50.

Further in this regard, the toggle pulse generation network 130 of the receiver circuit 100 is operably coupled with the phase change detection network 120 and is operable to receive the phase change indication output signal 54 and generate pulses based on the phase changes identified in the conditioned PLC output signal 50. The toggle pulse generation network 130 is further operable to generate a toggle pulse output signal 60 representative of the generated pulses.

Yet still further in this regard, the bit pattern generation network 140 of the receiver circuit 100 is operably coupled with the toggle pulse generation network 130 and is operable to receive the toggle pulse output signal 60 and determine PLC message body data of a PLC message based on the pulses represented in the received toggle pulse output signal 60. The bit pattern generation network 140 is further operable to generate a PLC data body part bit pattern output signal 64 representative of the determined PLC message body data.

In accordance with the example implementations described herein, the generated PLC data body part bit pattern output signal 64 is usable by an associated processing element 20 for processing the PLC message.

In accordance with the example implementations described herein, the receiver circuit 100 comprising the decoupling network 110, the phase change detection network 120, the toggle pulse generation network 130, and the bit pattern generation network 140 may comprise one or more discrete components as will be described herein and, in addition, may comprise one or more processors operatively coupled with a non-transitory computer readable storage medium storing computer program instructions thereon that, when executed by the one or more processors, cause the one or more processors to decode a data body part of a power line communication (PLC) message into a bit pattern for use by an associated processing element.

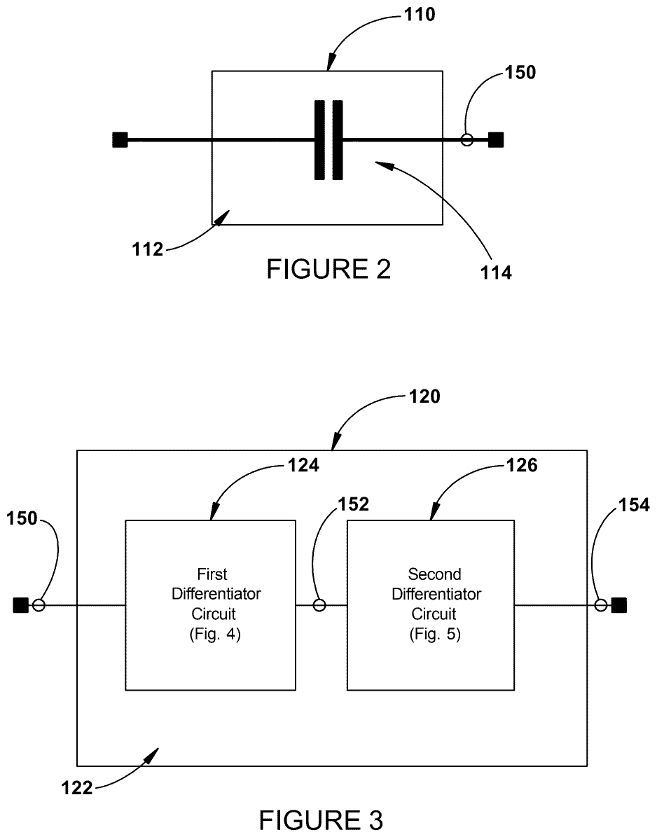

With reference to FIG. 2, the decoupling network 110 in accordance with an example implementation comprises a bandpass circuit 112 that adapts the receiver circuit 100 for operative connection with the power line 10 of the associated vehicle 1. As described, the power line 10 may carry PLC data carried in PLC signals in the form of informational data and control messages for distributed communication amongst and between one or more control devices of the associated vehicle such as brake control devices, throttle control devices, lane departure warning controllers, various operator assist control devices, and the like.

In accordance with the example implementation, the bandpass circuit 112 of the decoupling network circuit 110 acts as a filter for isolating the receiver circuit 100 from the direct current (DC) power of power line 10. The bandpass circuit 112 of the decoupling network circuit 110 further acts as a filter to permit non-direct current (AC) signals carried on the power line 10 of the associated vehicle, such as for example PLC data and control messages, to pass into the receiver circuit 110 as the conditioned output PLC signal 50 to be processed in the manner and ways described below in detail to extract the data from the PLC messages in accordance with the example implementation.

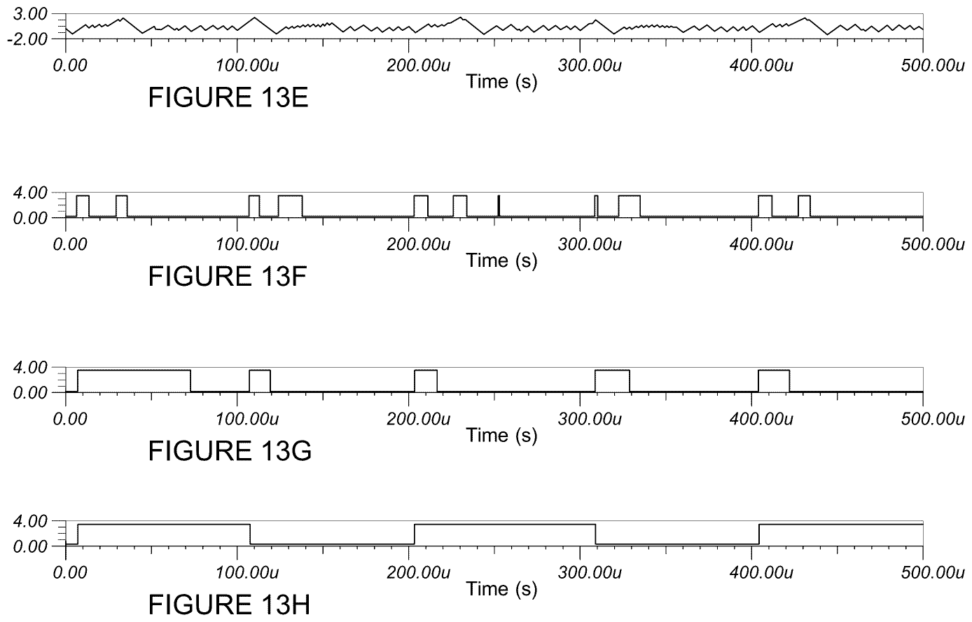

In accordance with the example implementation illustrated, the bandpass circuit 112 of the decoupling network circuit 110 comprises a capacitor 114, for example. It is to be appreciated that although a single capacitor 114 is illustrated in the FIGURE, the bandpass circuit 112 may take on various other forms that have overall characteristics of a capacitor for isolating or otherwise filtering the receiver circuit 100 from the DC component of the power line 10, while simultaneously permitting AC voltage signals carried on the power line 10 to pass into the receiver circuit 110 to be processed. The decoupling network circuit 110 generates an AC conditioned PLC signal 150 as the conditioned output PLC signal 50 for delivery of the AC conditioned PLC signal 150 to the phase change detection network 120 is illustrated for example in FIG. 13A.

It is to be appreciated that with regard to the AC conditioned PLC signal 150 delivered from the decoupling network 110 to the phase change detection network 120, the PLC message has in general a phase change at every 100 microseconds as shown in FIG. 13A.

In general, each PLC message comprises a preamble portion, and a data body portion. The preamble portion of each PLC message is a part of the PLC message that establishes communication between a transmitter (not shown) on the power line 10 and the subject receiver 100, and the data body portion is a part of the message that carries the data part of the message to be communicated from transmitters on the power line 10 to receivers on the power line 10. In general, the preamble portion together with the data body part comprises a PLC message. In accordance with the example implementations described herein, the subject receiver circuit 100 operates to decode the data body portion of PLC messages that are presented onto the power line 10.

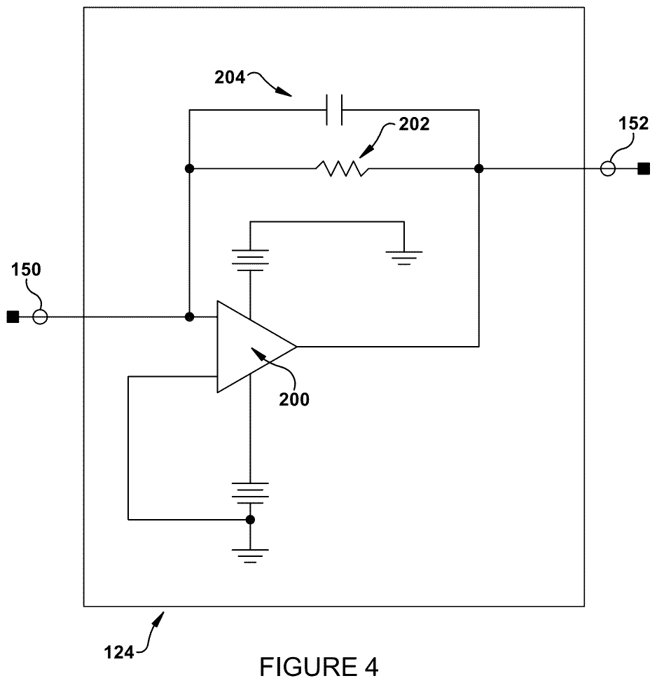

The decoupling network 110 comprising the bandpass circuit 112 is coupled with the phase change detection network 120 as described and shown in FIG. 1, wherein the phase change detection network 120 includes a differentiator network circuit 122 as shown in FIG. 3. With reference to that Figure, the differentiator network circuit 122 is operable to decode data body parts of the PLC messages that consist of phase shift keyed (PSK) waveforms in which data bits are embedded in the form of phase shifts of sinusoidal chirps in the PLC message signals.

The differentiator network circuit 122 receives the AC conditioned PLC signal 150 (FIG. 13A) delivered from the bandpass circuit 112 and processes the AC conditioned PLC signal 150 to generate an output signal 154 such as shown for example in FIG. 13C. The output signal 154 generated by the differentiator network circuit 122 is representative of phase changes identified by the differentiator network circuit 122 in the received AC conditioned PLC signal 150.

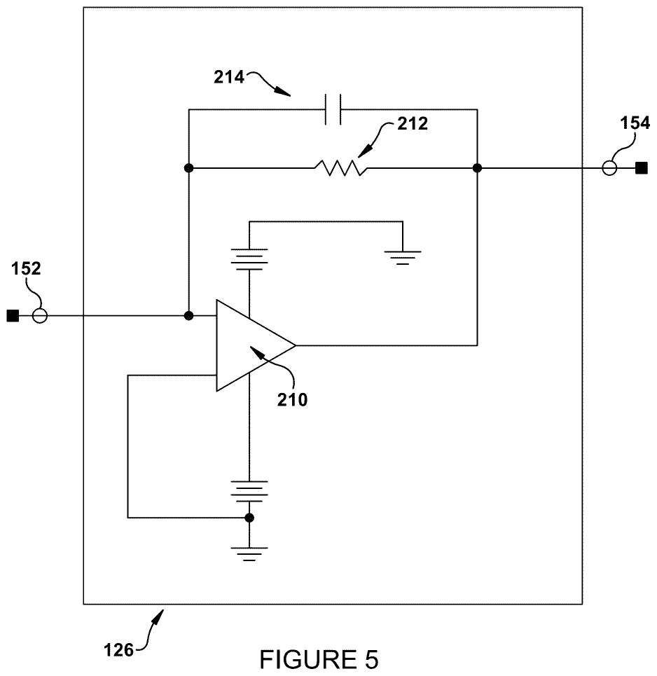

In the example implementation, the differentiator network circuit 122 includes a first differentiator circuit 124 coupled with a second differentiator circuit 126 as shown in FIG. 3. Details of the first differentiator circuit 124 in accordance with an example implementation are shown in FIG. 4. The first differentiator circuit 124 includes an operational amplifier (op-amp) 200, a feedback resistor 202, and a feedback capacitor 204. In this topology the first differentiator circuit 124 differentiates the AC conditioned PLC signal 150 for determining phase changes in the received AC conditioned PLC signal 150.

The first differentiator circuit 124 is operable to receive the AC conditioned PLC signal 150, identify phase changes in the received AC conditioned PLC signal 150, and generate a first differentiated phase change indication output signal 152 representative of the phase changes identified in the received AC conditioned PLC signal 150. FIG. 13B is a representative waveform diagram showing the waveform of the first differentiated phase change indication output signal 152 taken at the output of the first differentiator circuit 124.

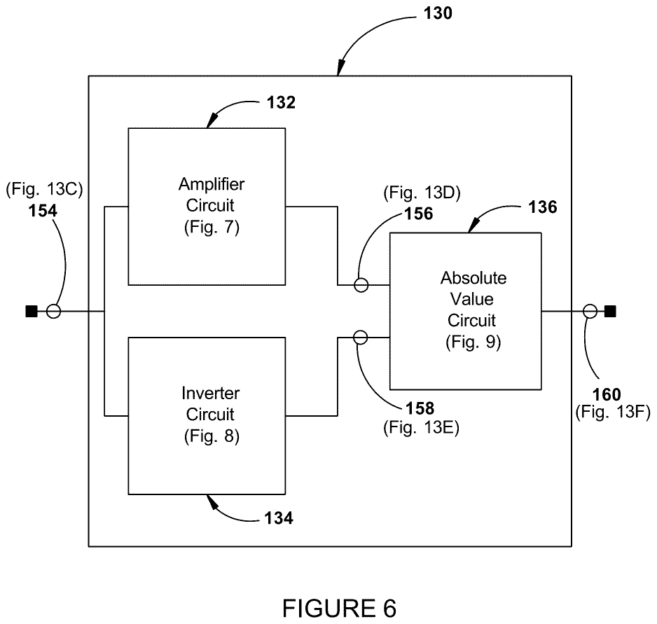

Similarly, the details of the second differentiator circuit 126 in accordance with an example implementation are shown in FIG. 5. The second differentiator circuit 126 includes an operational amplifier (op-amp) 210, a feedback resistor 212, and a feedback capacitor 214. In this topology the second differentiator circuit 126 differentiates the first differentiated phase change indication output signal 152 received from the first differentiator circuit 124 for accentuating the determined phase changes in the received signal 152.

The second differentiator circuit 126 is operable to receive the first differentiated phase change indication output signal 152, accentuate the phase changes identified by the first differentiator circuit 124 in the received AC conditioned PLC signal 150, and generate an accentuated differentiated phase change indication output signal 154 representative of the accentuated phase changes identified by the first differentiator circuit in the received AC conditioned PLC signal 150. FIG. 13C is a representative waveform diagram showing the waveform of the accentuated differentiated phase change indication output signal 154 taken at the output of the second differentiator circuit 126.

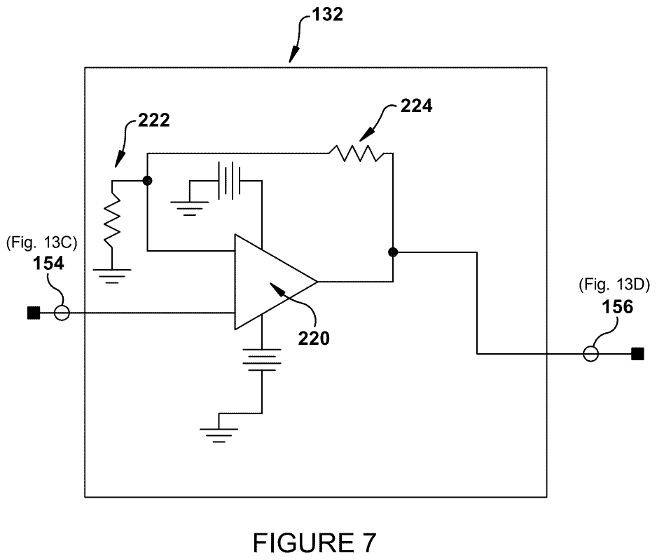

FIG. 6 is a block diagram representation of the toggle pulse generation network 130 of the subject receiver circuit 100 in accordance with an example embodiment. As shown, the toggle pulse generation network 130 includes an amplifier circuit 132, an inverter circuit 134, and an absolute value circuit 136.

In accordance with an example implementation, the amplifier circuit 132 is configured to receive the phase change indication output signal 54 from the phase change detection network 120 as an accentuated differentiated phase change indication output signal 154, and amplify the accentuated differentiated phase change indication output signal 154. The amplifier circuit 132 is further configured to generate an amplified accentuated differentiated phase change indication output signal 156. The amplified accentuated differentiated phase change indication output signal 156 has a waveform such as shown in FIG. 13D, for example.

Further in accordance with the example implementation, the inverter circuit 134 is configured to receive the phase change indication output signal 54 from the phase change detection network 120 as an accentuated differentiated phase change indication output signal 154, and invert the accentuated differentiated phase change indication output signal 154. The inverter circuit 134 is further configured to generate an inverted accentuated differentiated phase change indication output signal 158. The inverted accentuated differentiated phase change indication output signal 158 has a waveform such as shown in FIG. 13E, for example.

Still further in accordance with the example implementation, the absolute value circuit 136 is configured to receive the generated amplified accentuated differentiated phase change indication output signal 156, and also receive the generated inverted accentuated differentiated phase change indication output signal 158. The absolute value circuit 136 is further configured to logically combine the generated amplified accentuated differentiated phase change indication output signal 156 and the generated inverted accentuated differentiated phase change indication output signal 158 and generate the toggle pulse output signal 60 as an absolute value toggle pulse output signal 160 representative of the pulses generated based on the phase changes identified in the conditioned PLC output signal 50. The absolute value toggle pulse output signal 160 has a waveform such as shown in FIG. 13F, for example.

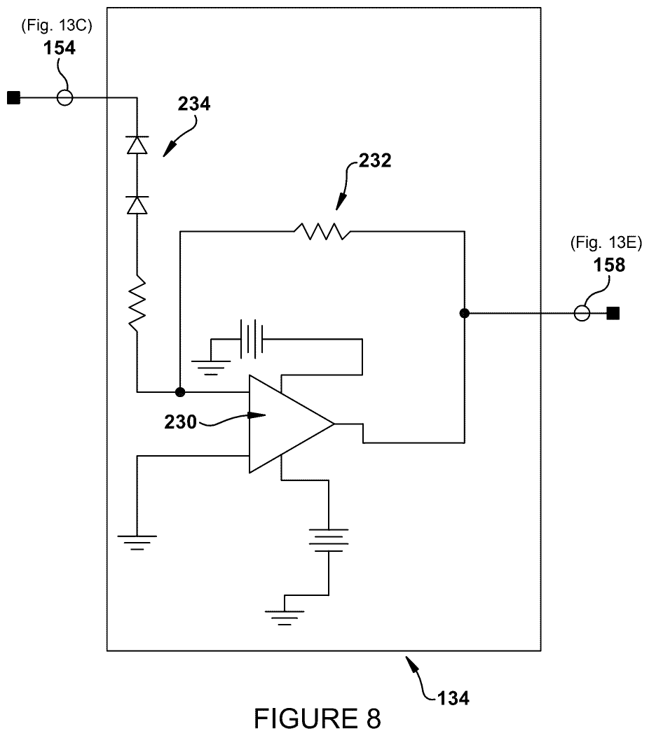

FIG. 7 is a schematic circuit representation of the amplifier circuit 132 portion of the toggle pulse generation network 130 of FIG. 6 in accordance with an example embodiment.

The amplifier circuit 132 includes an operational amplifier (op-amp) 220, a first feedback resistor 222, and a second feedback resistor 224. In this topology the amplifier circuit 132 amplifies the received accentuated differentiated phase change indication output signal 154 to generate the amplified accentuated differentiated phase change indication output signal 156 (FIG. 13D) based on a ratio between the first and second feedback resistors 222, 224.

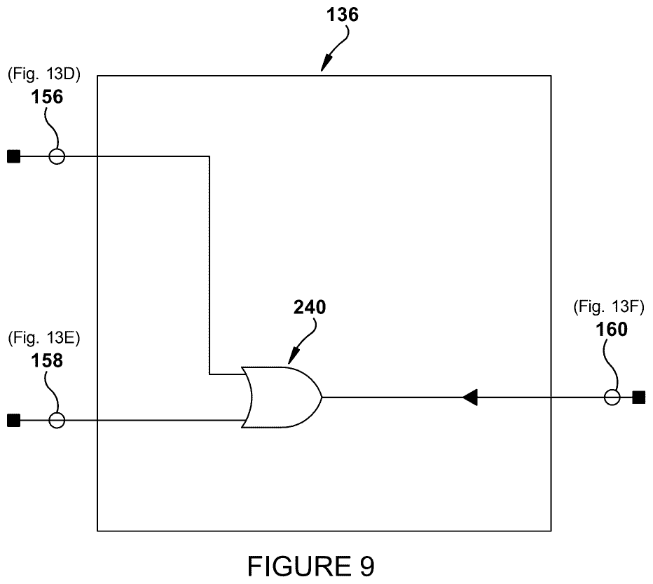

FIG. 8 is a schematic circuit representation of the inverting circuit 134 portion of the toggle pulse generation network 130 of FIG. 6 in accordance with an example embodiment. The inverting circuit 134 includes an operational amplifier (op-amp) 230, a feedback resistor 232, and a diode stack 234. In this topology inverting circuit 134 inverts the accentuated differentiated phase change indication output signal 154, and generates the inverted accentuated differentiated phase change indication output signal 158 (FIG. 13E).

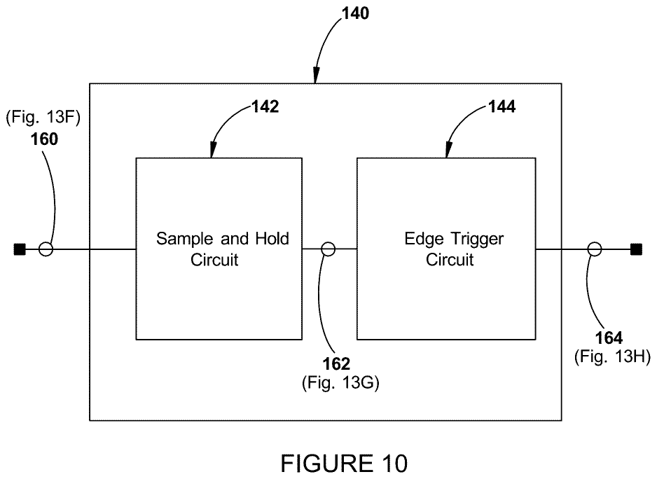

FIG. 9 is a schematic circuit representation of the absolute value circuit 136 portion of the toggle pulse generation network of FIG. 6 in accordance with an example embodiment. The absolute value circuit 136 includes a logical gate device 240 that receives the amplified accentuated differentiated phase change indication output signal 156 as well as the generated inverted accentuated differentiated phase change indication output signal 158. The logical gate device 240 is operable to logically combine the amplified accentuated differentiated phase change indication output signal 156 and the inverted accentuated differentiated phase change indication output signal 158, and generate the toggle pulse output signal 60 as an absolute value toggle pulse output signal 160 (FIG. 13F).

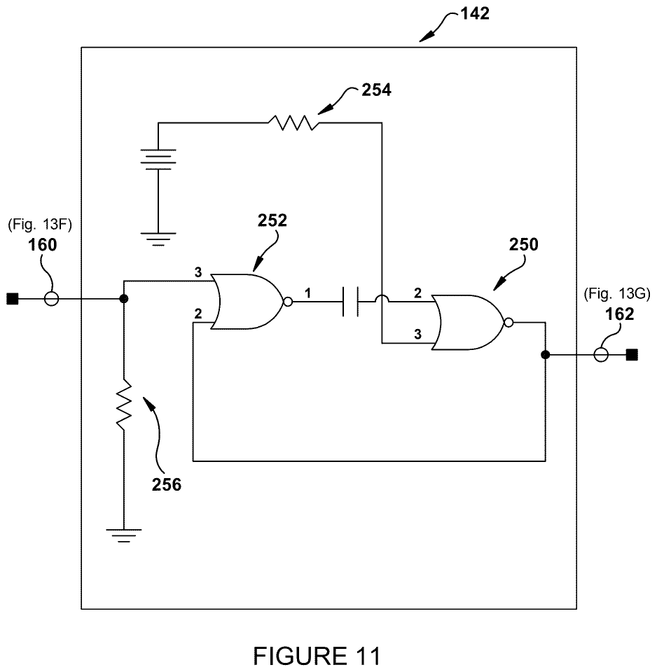

FIG. 10 is a block diagram representation of the bit pattern generation network 140 of FIG. 1 in accordance with an example embodiment. As shown, the bit pattern generation network 140 includes a sample and hold circuit 142 and an edge trigger circuit 144 in accordance with example implementation.

The sample and hold circuit 142 of the bit pattern generation network 140 in accordance with an example embodiment is operable to receive the toggle pulse output signal 60 from the toggle pulse generation network 130 as an absolute value toggle pulse output signal 160 (FIG. 13F) representative of the pulses generated based on the phase changes identified in the conditioned PLC output signal 50. The sample and hold circuit 142 is further operable to sample a logic level of the absolute value toggle pulse output signal 160, and mask extraneous logic level changes by delaying reporting the logic level of the absolute value toggle pulse output signal 160 based on a predetermined hold time period. The sample and hold circuit 142 is further operable to generate a sample and hold output signal 162 representative of the delayed logic level reporting of the absolute value toggle pulse output signal 160 based on the predetermined hold time period. In accordance with an example embodiment, the sample and hold output signal 162 has a waveform such as shown in FIG. 13G, for example.

The edge trigger circuit 144 of the bit pattern generation network 140 in accordance with an example embodiment is operable to receive the sample and hold output signal 162 and determine the PLC message body data of the PLC message based on the pulses represented in the received sample and hold output signal 162. The edge trigger circuit 144 is further operable to generate the PLC data body part bit pattern output signal 64 as a corrected masked bit pattern output signal 164, wherein the corrected masked bit pattern output signal 164 being representative of the determined PLC message body data. The corrected masked bit pattern output signal 164 has a waveform such as shown in FIG. 13H, for example.

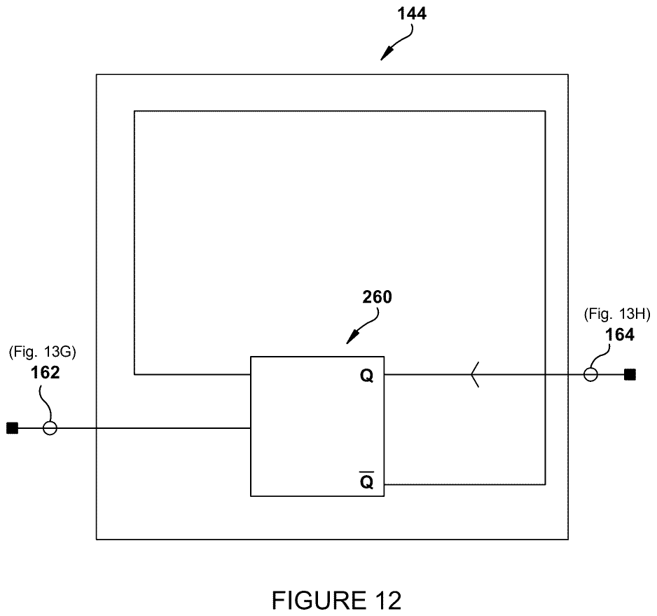

FIG. 11 is a schematic circuit representation of the sample and hold circuit 142 portion of the bit pattern generation network 140 of FIG. 10 in accordance with an example embodiment. The sample and hold circuit 142 in accordance with the example embodiment includes a pair of logic devices 250, 252 and a pair of resistors 254, 256 arranged substantially as shown in the Figure. As described above, the sample and hold circuit 142 is operable to sample a logic level of the absolute value toggle pulse output signal 160, and mask extraneous logic level changes by delaying reporting the logic level of the absolute value toggle pulse output signal 160 based on a predetermined hold time period. The sample and hold circuit 142 is further operable to generate a sample and hold output signal 162 representative of the delayed logic level reporting of the absolute value toggle pulse output signal 160 based on the predetermined hold time period. In accordance with an example embodiment, the sample and hold output signal 162 has a waveform such as shown in FIG. 13G, for example.

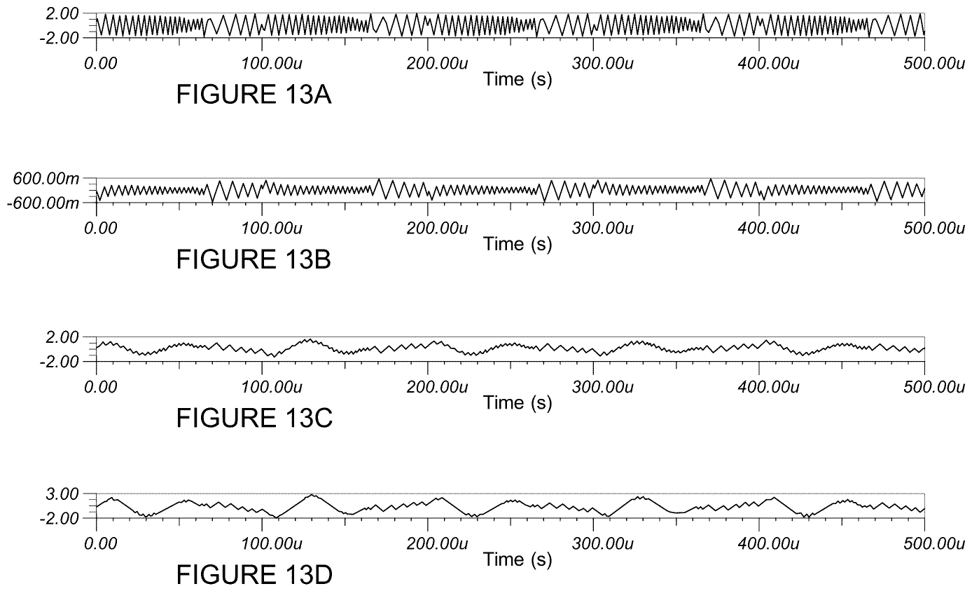

FIG. 12 is a schematic circuit representation of an edge trigger circuit 144 portion of the bit pattern generation network of FIG. 10 in accordance with an example embodiment. The edge trigger circuit 144 in accordance with the example embodiment includes a flip-flop logic device 260 arranged substantially as shown in the Figure. As described above, the edge trigger circuit 144 of the bit pattern generation network 140 in accordance with an example embodiment is operable to receive the sample and hold output signal 162 and determine the PLC message body data of the PLC message based on the pulses represented in the received sample and hold output signal 162. The edge trigger circuit 144 is further operable to generate the PLC data body part bit pattern output signal 64 as a corrected masked bit pattern output signal 164, wherein the corrected masked bit pattern output signal 164 being representative of the determined PLC message body data. The corrected masked bit pattern output signal 164 has a waveform such as shown in FIG. 13H, for example.

It is to be appreciated that the sample and hold circuit 142 together with the edge trigger circuit 144 operate in accordance with the example embodiment as a mono-stable multi-vibrator (MSMV) and toggle circuit.

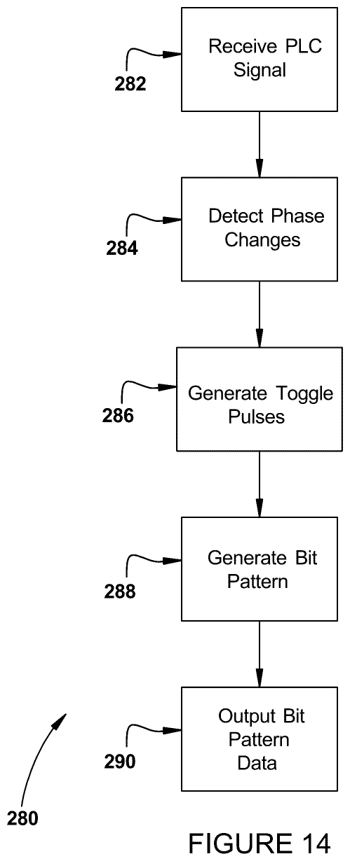

FIG. 14 is a flow diagram showing a method 280 for detecting data in PLC messages in accordance with an example embodiment. In accordance with an implementation, the method 280 may be performed by a receiver circuit 100 operable to decode a data body part of a power line communication (PLC) message into a bit pattern for use by an associated processing element 20. In accordance with a further implementation, the method 280 may be performed by one or more processors executing computer program instructions stored on a non-transitory computer readable storage medium for decoding a data body part of a power line communication (PLC) message into a bit pattern for use by an associated processing element.

In accordance with a further aspect, a non-transitory computer readable storage medium is provided comprising computer program instructions for decoding a data body part of a power line communication (PLC) message into a bit pattern for use by an associated processing element, the computer program instructions, when executed by one or more processors, causing the one or more processors to receive a raw PLC signal from the power line, filter the raw PLC signal by removing static features from the raw PLC signal to generate a conditioned PLC output signal, identify phase changes in the conditioned PLC output signal, generate a phase change indication output signal representative of the phase changes identified in the received conditioned PLC output signal, generate pulses based on the phase changes identified in the conditioned PLC output signal, generate a toggle pulse output signal representative of the generated pulses, determine PLC message body data of a PLC message based on the pulses represented in the toggle pulse output signal, and generate a PLC data body part bit pattern output signal representative of the determined PLC message body data, wherein the generated PLC data body part bit pattern output signal is usable by the associated processing element for processing the PLC message.

A PLC signal is received at 282. In accordance with an implementation, a decoupling network 110 operably coupled with a power line 10 of an associated vehicle 1 is operable to receive a raw PLC signal 40 from the power line 10, and filter the raw PLC signal 40 by removing static features from the raw PLC signal 40 to generate a conditioned PLC output signal 50.

In accordance with an implementation, the raw PLC signal 40 is filtered to permit non-direct current (AC) signals carried on the power line 10 to pass into the receiver circuit 110 as an AC conditioned PLC signal 150. The raw PLC signal 40 may be filtered by a bandpass circuit 112, for example.

In any of the implementations, the non-transitory computer readable storage medium comprising the computer program instructions, when executed by the one or more processors, further cause the one or more processors to filter the raw PLC signal to permit non-direct current (AC) signals carried on the power line to pass as an AC conditioned PLC signal.

Phase changes in the PLC signal received at 282 are detected at 284. In accordance with an implementation, a phase change detection network 120 operably coupled with the decoupling network 110 is operable to receive the conditioned PLC output signal 50, identify phase changes in the received conditioned PLC output signal 50, and generate a phase change indication output signal 54 representative of the phase changes identified in the received conditioned PLC output signal 50.

In any of the implementations, the non-transitory computer readable storage medium comprising the computer program instructions, when executed by the one or more processors, further cause the one or more processors to identify phase changes in the AC conditioned PLC signal, generate a first differentiated phase change indication output signal representative of the phase changes identified in the AC conditioned PLC signal, accentuate the phase changes identified in the AC conditioned PLC signal, and generate an accentuated differentiated phase change indication output signal representative of the accentuated phase changes identified in the AC conditioned PLC signal.

In accordance with an implementation, the phase change indication output signal 54 representative of the phase changes identified in the received conditioned PLC output signal 50 may be generated by a differentiator network circuit 120 of the phase change detection network 120, wherein the differentiator network circuit 120 includes first and second differentiator circuits. The method includes receiving, by the first differentiator circuit, the conditioned PLC output signal as an AC conditioned PLC signal, identifying, by the first differentiator circuit, phase changes in the received AC conditioned PLC signal, and generating, by the first differentiator circuit, a first differentiated phase change indication output signal representative of the phase changes identified in the received AC conditioned PLC signal. The method further includes receiving, by the second differentiator circuit, the first differentiated phase change indication output signal, accentuating, by the second differentiator circuit, the phase changes identified by the first differentiator circuit in the received AC conditioned PLC signal, and generating, by the second differentiator circuit, an accentuated differentiated phase change indication output signal representative of the accentuated phase changes identified by the first differentiator circuit in the received AC conditioned PLC signal.

In any of the implementations, the non-transitory computer readable storage medium comprising the computer program instructions, when executed by the one or more processors, further cause the one or more processors to receive the phase change indication output signal as an accentuated differentiated phase change indication output signal, amplify the accentuated differentiated phase change indication output signal, generate an amplified accentuated differentiated phase change indication output signal, invert the accentuated differentiated phase change indication output signal, generate an inverted accentuated differentiated phase change indication output signal, logically combine the generated amplified accentuated differentiated phase change indication output signal and the generated inverted accentuated differentiated phase change indication output signal, and generate the toggle pulse output signal as an absolute value toggle pulse output signal representative of the pulses generated based on the phase changes identified in the conditioned PLC output signal.

Toggle pulses are generated at 288. In accordance with an implementation, a toggle pulse generation network 130 operably coupled with the phase change detection network 120 is operable to receive the phase change indication output signal 54, generate pulses based on the phase changes identified in the conditioned PLC output signal 50, and generate a toggle pulse output signal 60 representative of the generated pulses.

In accordance with an implementation, the toggle pulse output signal 60 representative of the generated pulses may be generated by amplifier, inverter, and absolute value circuits of a toggle pulse generation network 130.

The method includes receiving, by the amplifier circuit 132, a phase change indication output signal 54 from the phase change detection network 120 as an accentuated differentiated phase change indication output signal 154, amplifying the accentuated differentiated phase change indication output signal 154, and generating an amplified accentuated differentiated phase change indication output signal 156. The method further includes receiving, by the inverter circuit 134, the phase change indication output signal 54 from the phase change detection network 120 as an accentuated differentiated phase change indication output signal 154, inverting the accentuated differentiated phase change indication output signal 154, and generating an inverted accentuated differentiated phase change indication output signal 158. The method further includes receiving, by the absolute value circuit 136, the generated amplified accentuated differentiated phase change indication output signal 156, receiving the generated inverted accentuated differentiated phase change indication output signal 158, logically combining the generated amplified accentuated differentiated phase change indication output signal 156 and the generated inverted accentuated differentiated phase change indication output signal 158, and generating the toggle pulse output signal 60 as an absolute value toggle pulse output signal 160 representative of the pulses generated based on the phase changes identified in the conditioned PLC output signal 50.

In any of the implementations, the non-transitory computer readable storage medium comprising the computer program instructions, when executed by the one or more processors, further cause the one or more processors to sample a logic level of the absolute value toggle pulse output signal, mask extraneous logic level changes by delaying reporting the logic level of the absolute value toggle pulse output signal based on a predetermined hold time period, generate a sample and hold output signal representative of the delayed logic level reporting of the absolute value toggle pulse output signal based on the predetermined hold time period, determine the PLC message body data of the PLC message based on the pulses represented in the received sample and hold output signal, and generate the PLC data body part bit pattern output signal as a corrected masked bit pattern output signal, the corrected masked bit pattern output signal being representative of the determined PLC message body data.

Bit pattern data is outputted at 290, wherein the generated PLC data body part bit pattern output signal is usable by an associated processing element for processing the PLC message. In accordance with an implementation, a bit pattern generation network 140 operably coupled with the toggle pulse generation network 130 is operable to receive the toggle pulse output signal 60, determine PLC message body data of a PLC message based on the pulses represented in the received toggle pulse output signal 60, and generate a PLC data body part bit pattern output signal 64 representative of the determined PLC message body data.

The method includes receiving by a sample and hold circuit 142 of the bit pattern generation network 140 the toggle pulse output signal 60 from the toggle pulse generation network 130 as an absolute value toggle pulse output signal 160 representative of the pulses generated based on the phase changes identified in the conditioned PLC output signal 50, sampling, by the sample and hold circuit 142, a logic level of the absolute value toggle pulse output signal 160, masking, by the sample and hold circuit 142, extraneous logic level changes by delaying reporting the logic level of the absolute value toggle pulse output signal 160 based on a predetermined hold time period, and generating, by the sample and hold circuit 142, a sample and hold output signal 162 representative of the delayed logic level reporting of the absolute value toggle pulse output signal 160 based on the predetermined hold time period. The method further includes receiving, by the edge trigger circuit 144, the sample and hold output signal 162, determining, by the edge trigger circuit 144, the PLC message body data of the PLC message based on the pulses represented in the received sample and hold output signal 162, and generating, by the edge trigger circuit 144, the PLC data body part bit pattern output signal 64 as a corrected masked bit pattern output signal 164, the corrected masked bit pattern output signal 164 being representative of the determined PLC message body data.

As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

1. A receiver circuit for decoding a data body part of a power line communication (PLC) message into a bit pattern for use by an associated processing element, the receiver circuit comprising:
a decoupling network operably coupled with a power line of an associated vehicle, the decoupler network being operable to:
receive a raw PLC signal from the power line; and
filter the raw PLC signal by removing static features from the raw PLC signal to generate a conditioned PLC output signal;
a phase change detection network operably coupled with the decoupling network and being operable to:
receive the conditioned PLC output signal;
identify phase changes in the received conditioned PLC output signal; and
generate a phase change indication output signal representative of the phase changes identified in the received conditioned PLC output signal;
a toggle pulse generation network operably coupled with the phase change detection network and being operable to:
receive the phase change indication output signal;
generate pulses based on the phase changes identified in the conditioned PLC output signal; and
generate a toggle pulse output signal representative of the generated pulses; and
a bit pattern generation network operably coupled with the toggle pulse generation network and being operable to:
receive the toggle pulse output signal;
determine PLC message body data of a PLC message based on the pulses represented in the received toggle pulse output signal; and
generate a PLC data body part bit pattern output signal representative of the determined PLC message body data,
wherein the generated PLC data body part bit pattern output signal is usable by an associated processing element for processing the PLC message.

2. The receiver circuit according to claim 1, wherein the decoupling network comprises:
a bandpass circuit operable filter the raw PLC signal to permit non-direct current (AC) signals carried on the power line to pass into the receiver circuit as an AC conditioned PLC signal.

3. The receiver circuit according to claim 1, wherein the phase change detection network comprises:
a differentiator network circuit comprising:
a first differentiator circuit operable to:
receive the conditioned PLC output signal as an AC conditioned PLC signal;
identify phase changes in the received AC conditioned PLC signal; and
generate a first differentiated phase change indication output signal representative of the phase changes identified in the received AC conditioned PLC signal; and
a second differentiator circuit operable to:
receive the first differentiated phase change indication output signal;
accentuate the phase changes identified by the first differentiator circuit in the received AC conditioned PLC signal; and
generate an accentuated differentiated phase change indication output signal representative of the accentuated phase changes identified by the first differentiator circuit in the received AC conditioned PLC signal.

4. The receiver circuit according to claim 1, wherein the toggle pulse generation network comprises:
an amplifier circuit configured to:
receive the phase change indication output signal from the phase change detection network as an accentuated differentiated phase change indication output signal;
amplify the accentuated differentiated phase change indication output signal; and
generate an amplified accentuated differentiated phase change indication output signal;
an inverter circuit configured to:
receive the phase change indication output signal from the phase change detection network as an accentuated differentiated phase change indication output signal;
invert the accentuated differentiated phase change indication output signal; and
generate an inverted accentuated differentiated phase change indication output signal; and
an absolute value circuit configured to:
receive the generated amplified accentuated differentiated phase change indication output signal;
receive the generated inverted accentuated differentiated phase change indication output signal;
logically combine the generated amplified accentuated differentiated phase change indication output signal and the generated inverted accentuated differentiated phase change indication output signal; and
generate the toggle pulse output signal as an absolute value toggle pulse output signal representative of the pulses generated based on the phase changes identified in the conditioned PLC output signal.

5. The receiver circuit according to claim 1, wherein the bit pattern generation network comprises:
a sample and hold circuit operable to:
receive the toggle pulse output signal from the toggle pulse generation network as an absolute value toggle pulse output signal representative of the pulses generated based on the phase changes identified in the conditioned PLC output signal;
sample a logic level of the absolute value toggle pulse output signal;
mask extraneous logic level changes by delaying reporting the logic level of the absolute value toggle pulse output signal based on a predetermined hold time period; and
generate a sample and hold output signal representative of the delayed logic level reporting of the absolute value toggle pulse output signal based on the predetermined hold time period; and
an edge trigger circuit operable to:
receive the sample and hold output signal;
determine the PLC message body data of the PLC message based on the pulses represented in the received sample and hold output signal; and
generate the PLC data body part bit pattern output signal as a corrected masked bit pattern output signal, the corrected masked bit pattern output signal being representative of the determined PLC message body data.

6. A method for decoding a data body part of a power line communication (PLC) message into a bit pattern for use by an associated processing element, the method comprising:
receiving a raw PLC signal from the power line;
filtering the raw PLC signal by removing static features from the raw PLC signal to generate a conditioned PLC output signal;
identifying phase changes in the conditioned PLC output signal;
generating a phase change indication output signal representative of the phase changes identified in the received conditioned PLC output signal;
generating pulses based on the phase changes identified in the conditioned PLC output signal;
generating a toggle pulse output signal representative of the generated pulses;
determining PLC message body data of a PLC message based on the pulses represented in the toggle pulse output signal; and
generating a PLC data body part bit pattern output signal representative of the determined PLC message body data,
wherein the generated PLC data body part bit pattern output signal is usable by the associated processing element for processing the PLC message.

7. The method according to claim 6, further comprising:
filtering the raw PLC signal to permit non-direct current (AC) signals carried on the power line to pass as an AC conditioned PLC signal.

8. The method according to claim 6, further comprising:
identifying phase changes in the AC conditioned PLC signal;
generating a first differentiated phase change indication output signal representative of the phase changes identified in the AC conditioned PLC signal;
accentuating the phase changes identified in the AC conditioned PLC signal; and
generating an accentuated differentiated phase change indication output signal representative of the accentuated phase changes identified in the AC conditioned PLC signal.

9. The method according to claim 6, further comprising:
receiving the phase change indication output signal as an accentuated differentiated phase change indication output signal;
amplifying the accentuated differentiated phase change indication output signal;
generating an amplified accentuated differentiated phase change indication output signal;
inverting the accentuated differentiated phase change indication output signal;
generating an inverted accentuated differentiated phase change indication output signal;
logically combining the generated amplified accentuated differentiated phase change indication output signal and the generated inverted accentuated differentiated phase change indication output signal; and
generating the toggle pulse output signal as an absolute value toggle pulse output signal representative of the pulses generated based on the phase changes identified in the conditioned PLC output signal.

10. The method according to claim 6, further comprising:
sampling a logic level of the absolute value toggle pulse output signal;
masking extraneous logic level changes by delaying reporting the logic level of the absolute value toggle pulse output signal based on a predetermined hold time period;
generating a sample and hold output signal representative of the delayed logic level reporting of the absolute value toggle pulse output signal based on the predetermined hold time period;
determining the PLC message body data of the PLC message based on the pulses represented in the received sample and hold output signal; and
generating the PLC data body part bit pattern output signal as a corrected masked bit pattern output signal, the corrected masked bit pattern output signal being representative of the determined PLC message body data.

11. A non-transitory computer readable storage medium comprising computer program instructions for decoding a data body part of a power line communication (PLC) message into a bit pattern for use by an associated processing element, the computer program instructions, when executed by one or more processors, causing the one or more processors to:
receive a raw PLC signal from the power line;
filter the raw PLC signal by removing static features from the raw PLC signal to generate a conditioned PLC output signal;
identify phase changes in the conditioned PLC output signal;
generate a phase change indication output signal representative of the phase changes identified in the received conditioned PLC output signal;
generate pulses based on the phase changes identified in the conditioned PLC output signal;
generate a toggle pulse output signal representative of the generated pulses;
determine PLC message body data of a PLC message based on the pulses represented in the toggle pulse output signal; and
generate a PLC data body part bit pattern output signal representative of the determined PLC message body data,
wherein the generated PLC data body part bit pattern output signal is usable by the associated processing element for processing the PLC message.

12. The non-transitory computer readable storage medium according to claim 11 wherein the computer program instructions, when executed by the one or more processors, further cause the one or more processors to:
filter the raw PLC signal to permit non-direct current (AC) signals carried on the power line to pass as an AC conditioned PLC signal.

13. The non-transitory computer readable storage medium according to claim 11 wherein the computer program instructions, when executed by the one or more processors, further cause the one or more processors to:
identify phase changes in the AC conditioned PLC signal;
generate a first differentiated phase change indication output signal representative of the phase changes identified in the AC conditioned PLC signal;
accentuate the phase changes identified in the AC conditioned PLC signal; and
generate an accentuated differentiated phase change indication output signal representative of the accentuated phase changes identified in the AC conditioned PLC signal.

14. The non-transitory computer readable storage medium according to claim 11 wherein the computer program instructions, when executed by the one or more processors, further cause the one or more processors to:
receive the phase change indication output signal as an accentuated differentiated phase change indication output signal;
amplify the accentuated differentiated phase change indication output signal;
generate an amplified accentuated differentiated phase change indication output signal;
invert the accentuated differentiated phase change indication output signal;
generate an inverted accentuated differentiated phase change indication output signal;
logically combine the generated amplified accentuated differentiated phase change indication output signal and the generated inverted accentuated differentiated phase change indication output signal; and
generate the toggle pulse output signal as an absolute value toggle pulse output signal representative of the pulses generated based on the phase changes identified in the conditioned PLC output signal.

15. The non-transitory computer readable storage medium according to claim 11 wherein the computer program instructions, when executed by the one or more processors, further cause the one or more processors to:
sample a logic level of the absolute value toggle pulse output signal;
mask extraneous logic level changes by delaying reporting the logic level of the absolute value toggle pulse output signal based on a predetermined hold time period;
generate a sample and hold output signal representative of the delayed logic level reporting of the absolute value toggle pulse output signal based on the predetermined hold time period;
determine the PLC message body data of the PLC message based on the pulses represented in the received sample and hold output signal; and
generate the PLC data body part bit pattern output signal as a corrected masked bit pattern output signal, the corrected masked bit pattern output signal being representative of the determined PLC message body data.
